(19) United States
(12) Patent Application Publication
(10) Pub. No.: US 2026/0128573 A1
(43) Pub. Date: May 7, 2026

(54) WIRE HARNESS

(71) Applicant: Sumitomo Wiring Systems, Ltd., Yokkaichi-shi (JP)

(72) Inventors: Takuya NAKAIZUMI, Yokkaichi-shi (JP); Yuichi Murakami, Yokkaichi-shi (JP); Katsutoshi Izawa, Yokkaichi-shi (JP)

(73) Assignee: Sumitomo Wiring Systems, Ltd., Yokkaichi-shi (JP)

(21) Appl. No.: 19/378,883

(22) Filed: Nov. 4, 2025

(30) Foreign Application Priority Data
Nov. 5, 2024 (JP) 2024-193841

(51) Int. Cl. H02G 3/04; B60R 16/02; H01B 7/00

(52) U.S. Cl. CPC H02G 3/0406; B60R 16/0215; H01B 7/0045; H02G 3/0468

(57) ABSTRACT

A wire harness that includes: an electric wire; an exterior cover that is configured to cover an outer periphery of the electric wire; and a waterproof cover that is configured to cover the outer periphery of the electric wire and be coupled to the exterior cover, wherein: the waterproof cover has a connecting tube that is configured to cover an outer periphery of the exterior cover, and a flat tube that is formed integrally with the connecting tube.

### BACKGROUND

The present disclosure relates to a wire harness.

Some conventional wire harnesses used in vehicles such as hybrid automobiles and electric automobiles are routed so as to pass outside the vehicle interior, such as under the floor of the vehicle. This type of wire harness includes electric wires, an exterior member such as a corrugated tube that covers the electric wires, and a rubber grommet that is attached to the outside of the exterior member (see JP 2015-015822A, for example). The grommet is attached in close contact with the outer peripheral surface of the exterior member to thereby function as a waterproof member that prevents intrusion of water into the exterior member and the grommet.

There is a demand for the above-described wire harness to have a lower profile.

An exemplary aspect of the disclosure provides a wire harness that can be made low-profile.

The wire harness of the present disclosure includes an electric wire member; an exterior member configured to cover an outer periphery of the electric wire member; and a waterproof member configured to cover the outer periphery of the electric wire member and be coupled to the exterior member, wherein the waterproof member has a connecting tube part configured to cover an outer periphery of the exterior member, and a flat tube part formed integrally with the connecting tube part, a transverse cross-sectional shape of the exterior member is a perfect circular shape, a transverse cross-sectional shape of the connecting tube part is a perfect circular shape, a transverse cross-sectional shape of the flat tube part is a flat shape in which a dimension along a second direction is larger than a dimension along a first direction, the first direction being orthogonal to an axial direction of the waterproof member and the second direction being orthogonal to both the axial direction and the first direction, and the dimension of the flat tube part along the first direction is smaller than a dimension of the connecting tube part along the first direction.

The wire harness of the present disclosure has an advantageous effect of being able to have a lower profile.

### BRIEF DESCRIPTION OF THE DRAWINGS

FIG. 1 is a schematic configuration diagram showing a wire harness according to an embodiment.

FIG. 2 is a perspective view of the wire harness according to the embodiment.

FIG. 3 is an exploded perspective view of the wire harness of the embodiment.

FIG. 4 is a cross-sectional view of the wire harness according to the embodiment.

FIG. 5 is a cross-sectional view (cross-sectional view taken along line 5-5 in FIG. 2) of the wire harness according to the embodiment.

FIG. 6 is an end view (end view taken along line 6-6 in FIG. 2) of the wire harness according to the embodiment.

FIG. 7 is a cross-sectional view of the wire harness according to the embodiment.

FIG. 8 is a perspective view showing a method for manufacturing the wire harness according to the embodiment.

FIG. 9 is an end view showing the method for manufacturing the wire harness according to the embodiment.

FIG. 10 is an end view of a portion of a wire harness according to a modified example.

FIG. 11 is an end view of a portion of a wire harness according to a modified example.

FIG. 12 is an end view showing a method for manufacturing a wire harness according to a modified example.

FIG. 13 is a perspective view of a waterproof member according to a modified example.

### EMBODIMENTS OF THE DISCLOSURE

### Description of Embodiments of Present Disclosure

First, embodiments of the present disclosure will be listed and described.

[1] A wire harness according to the present disclosure includes an electric wire member; an exterior member configured to cover an outer periphery of the electric wire member; and a waterproof member configured to cover the outer periphery of the electric wire member and be coupled to the exterior member, wherein the waterproof member has a connecting tube part configured to cover an outer periphery of the exterior member, and a flat tube part formed integrally with the connecting tube part, a transverse cross-sectional shape of the exterior member is a perfect circular shape, a transverse cross-sectional shape of the connecting tube part is a perfect circular shape, a transverse cross-sectional shape of the flat tube part is a flat shape in which a dimension along a second direction is larger than a dimension along a first direction, the first direction being orthogonal to an axial direction of the waterproof member and the second direction being orthogonal to both the axial direction and the first direction, and the dimension of the flat tube part along the first direction is smaller than a dimension of the connecting tube part along the first direction.

According to this configuration, the waterproof member is formed in a structure having the connecting tube part and the flat tube part. That is, a part of the waterproof member is formed as the flat tube part. The flat tube part here is formed in a flat shape that is longer in the second direction than in the first direction. The dimension of the flat tube part along the first direction is smaller than the dimension of the connecting tube part along the first direction. Therefore, the flat tube part can be lowered in profile in the first direction than the connecting tube part. This allows a portion of the waterproof member to be made low-profile in the first direction, and thus a portion of the wire harness to be made low-profile in the first direction.

If the transverse cross-sectional shape of either the exterior member or the connecting tube part is formed in a flat shape, the tensioning force cannot be applied evenly from the connecting tube part to the exterior member, which may result in a portion where the tensioning force is low, and reduce the water-stopping performance. In contrast, in the above configuration, the transverse cross-sectional shape of the exterior member is a perfect circular shape, and the transverse cross-sectional shape of the connecting tube part covering the outer periphery of the exterior member is a perfect circular shape. Therefore, as compared to the case where the transverse cross-sectional shape of either the exterior member or the connecting tube part is a flat shape, the tensioning force can be applied evenly from the connecting tube part to the exterior member over the entire circumference in the circumferential direction. This makes it possible to preferably maintain the water-tightness between the connecting tube part and the exterior member, thereby to preferably stop water between the connecting tube part and the exterior member. Therefore, while a portion of the wire harness is lowered in profile, it is possible to preferably prevent a reduction in the water-stopping performance between the exterior member and the waterproof member.

[2] In the above [1], the wire harness may further include a path restriction member configured to be attached to an outer periphery of the flat tube part and restrict a path of the electric wire member.

According to this configuration, the path restriction member capable of restricting the path of the electric wire member is attached to the outer periphery of the flat tube part. Accordingly, even if the waterproof member alone has low rigidity, for example, the path restriction member can suitably restrict the path of the electric wire member.

[3] In the above [2], the electric wire member may have k electric wires (k is a natural number greater than or equal to 3), the k electric wires may be arranged in n tiers (n is a natural number less than or equal to k−1 and greater than or equal to 2) in the first direction inside the connecting tube part, the k electric wires may be arranged in m tiers (m is a natural number less than or equal to than n−1) in the first direction inside the flat tube part, and the path restriction member may compress the flat tube part in the first direction such that the k electric wires are arranged in the m tiers inside the flat tube part.

According to this configuration, the number of tiers of the k electric wires in the first direction is set to n tiers inside the connecting tube part, and is set to m tiers, which is n−1 or less, inside the flat tube part. Therefore, the number of tiers of the k electric wires in the first direction inside the flat tube part is set to a number that is one or more smaller than the number of tiers of the k electric wires in the first direction inside the connecting tube part. Therefore, the flat tube part that stores the k electric wires arranged in m tiers can be suitably lowered in profile in the first direction.

[4] In the above [3], m may be one, and the path restriction member may compress the flat tube part in the first direction such that the k electric wires are arranged side by side along the second direction inside the flat tube part.

According to this configuration, the flat tube part is compressed in the first direction by the path restriction member, so that the k electric wires can be arranged side by side along the second direction inside the flat tube part. This allows the k electric wires to be arranged in one tier in the first direction inside the flat tube part, so that the flat tube part can be suitably lowered in profile in the first direction.

[5] In the above [3] or [4], the path restriction member may have a first divided body and a second divided body formed to be capable of being combined with the first divided body, and the path restriction member may be formed in a tubular shape that surrounds the outer periphery of the flat tube part by combining the first divided body and the second divided body, the first divided body may have a first bottom wall, the second divided body may have a second bottom wall that faces the first bottom wall in the first direction, and a first distance along the first direction between the first bottom wall and the second bottom wall may be smaller than a first dimension along the first direction of the k electric wires arranged in the n tiers.

According to this configuration, the path restriction member is formed in a tubular shape surrounding the outer periphery of the flat tube part by the first divided body and the second divided body. Accordingly, while the path restriction member is tubular in shape, the path restriction member is divided into the first divided body and the second divided body, so that the path restriction member can be attached to the electric wire member and the flat tube part at a later time. This improves the mountability of the path restriction member. Accordingly, the ease of assembling the wire harness can be improved.

[6] In any of the above [1] to [5], the transverse cross-sectional shape of the flat tube part may have two long side portions that extend along the second direction, two intermediate portions that are arranged between the two long side portions in the first direction and outward of the two long side portions in the second direction, and four inclined portions that connect both ends of the two long side portions to the two intermediate portions, the two long side portions may face each other in the first direction, the two intermediate portions may face each other in the second direction, and the four inclined portions may extend along an oblique direction intersecting both the first direction and the second direction and may be shorter than the two long side portions.

According to this configuration, the transverse cross-sectional shape of the flat tube part is formed to have the long side portions extending along the second direction, the inclined portions extending from the long side portions, and the intermediate portions connected to the inclined portions. The inclined portions are shorter than the long side portions. Accordingly, if the flat tube part is pressed such that the two intermediate portions approach each other, for example, the long side portions can be deformed more easily than the inclined portions, so that the flat tube parts can be deformed to extend in the first direction. Therefore, if the flat tube part is pressed such that the two intermediate portions approach each other, the flat tube part is deformed so as to become smaller in the second direction and become larger in the first direction. As a result, the difference between the dimension of the flat tube part in the first direction and the dimension of the flat tube part in the second direction can be reduced, and the transverse cross-sectional shape of the flat tube part can be changed from a flat shape toward a perfect circular shape. Therefore, during a routing operation of inserting the electric wire member into the inside of the waterproof member, the flat tube part can be deformed such that its transverse cross-sectional shape become closer to a perfect circular shape. This improves the ease of routing operation of the electric wire member. As a result, the ease of assembling the wire harness can be improved.

[7] In the above [6], the four inclined portions may be thicker than the two long side portions, the two intermediate portions may extend along the first direction, and the transverse cross-sectional shape of the flat tube part may be formed in an octagonal shape.

According to this configuration, the rigidity of the inclined portions can be made higher than the rigidity of the long side portions. Accordingly, if the flat tube part is pressed such that the two intermediate portions approach each other, for example, the long side portions can be deformed more easily than the inclined portions. Therefore, the flat tube part can be deformed to extend in the first direction.

[8] In any of the above [1] to [5], the transverse cross-sectional shape of the flat tube part may have two long side portions that extend along the second direction and two bellows portions that are provided between the two long side portions in the first direction, the two long side portions may face each other in the first direction, and the two bellows portions may face each other in the second direction.

According to this configuration, the bellows portions are provided on the short sides of the transverse cross-sectional shape of the flat tube part. Accordingly, the short sides can be provided with extra lengths by forming the short sides into bellows. Therefore, if the flat tube part is pressed such that the two bellows portions approach each other, for example, the bellows portions extend in the first direction, so that the flat tube part can be suitably deformed so as to extend greatly in the first direction.

[9] In any of the above [1] to [8], the flat tube part may have a bellows structure in which annular convex portions and annular concave portions are alternately and continuously provided along an axial direction of the flat tube part.

According to this configuration, providing the flat tube part with the bellows structure makes it possible to easily form a bent shape in a portion of the flat tube part in the axial direction.

### DETAILS OF EMBODIMENTS OF PRESENT DISCLOSURE

Specific examples of a wire harness of the present disclosure will be described below with reference to the drawings. In the drawings, for convenience of description, some of the configurations may be exaggerated or simplified. In addition, the dimensional ratio of each part may differ among the drawings. In this specification, the terms "parallel", "orthogonal", and "perfect circle" do not only mean strictly parallel, orthogonal, or perfect circle, but also include approximately parallel, orthogonal, or perfect circle to the extent that the actions and advantageous effects of the embodiment are achieved. The term "tubular" used in this specification means not only a tubular shape of a peripheral wall formed continuously in the circumferential direction, but also a tubular shape of a plurality of parts combined, and a tubular shape having a cut in a part of the circumference such as a C-shape. The "tubular" shape includes, but is not limited to, a circle, an ellipse, and a polygon with sharp or rounded corners. In this specification, the term "to face" means surfaces or members being in front of each other, and includes not only a case in which they are completely in front of each other, but also a case in which they are partially in front of each other. In addition, the term "to face" in this specification includes both a case where two parts have another member interposed therebetween and a case where the two parts have nothing interposed therebetween. The terms "first", "second", "third", and the like in this specification are used simply to distinguish objects and do not rank the objects. Note that the present disclosure is not limited to these examples, but rather is indicated by the claims, and is intended to include all modifications within the meaning and scope equivalent to the claims.

### Overall Configuration of Wire Harness 10

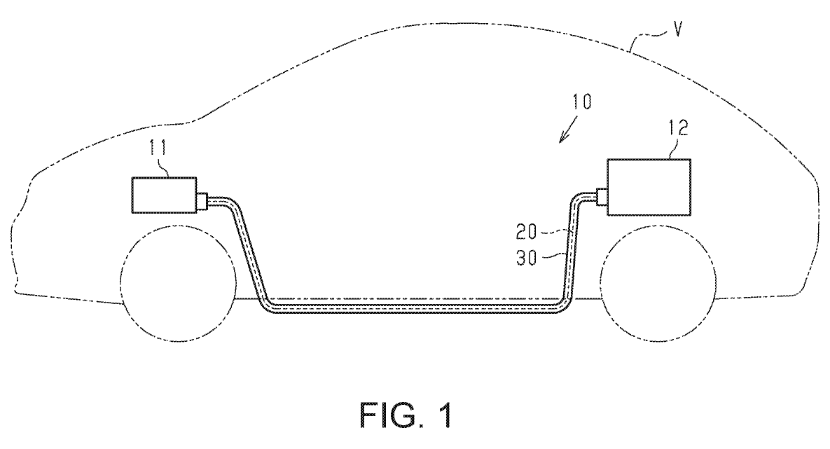

A wire harness 10 shown in FIG. 1 is mounted in a vehicle V such as a hybrid automobile or an electric automobile. The wire harness 10 electrically connects two or more in-vehicle devices to each other. The in-vehicle devices are electrical devices mounted in the vehicle V. The wire harness 10 electrically connects an inverter 11 installed in a front part of the vehicle V to a high-voltage battery 12 installed rearward of the inverter 11 in a rear part of the vehicle V, for example.

The inverter 11 is connected to a wheel drive motor (not shown) that serves as a motive power source for driving the vehicle. The inverter 11 generates alternating-current power from direct-current power of the high-voltage battery 12 and supplies the alternating-current power to the motor. The high-voltage battery 12 is a battery capable of supplying a voltage of several hundred volts, for example.

The wire harness 10 is routed so as to pass outside the vehicle interior, such as under the floor of the vehicle V, for example. The wire harness 10 is routed so as to extend from the inverter 11 to the space below the underfloor panel of the vehicle V, extend below the underfloor panel to the rear side of the vehicle V, and further extend upward to the high-voltage battery 12, for example.

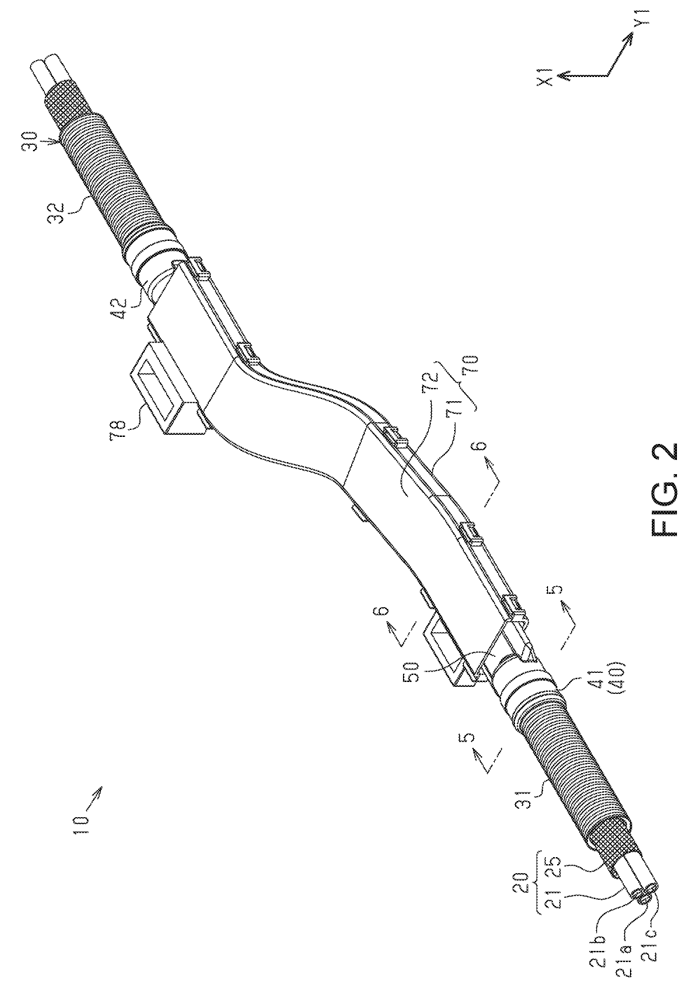

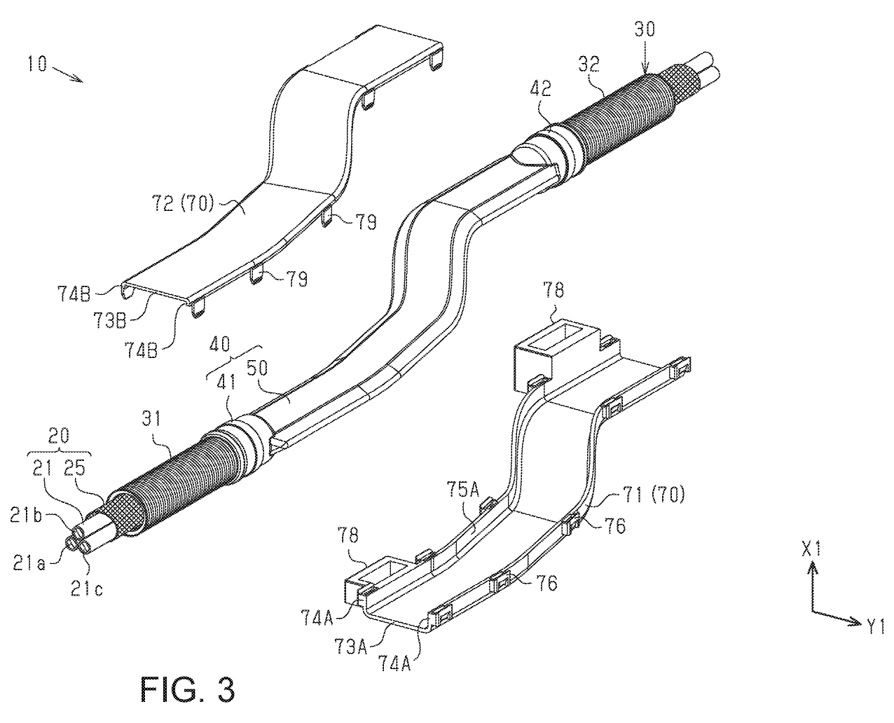

As shown in FIGS. 2 and 3, the wire harness 10 includes an electric wire member 20 and a tubular member 30 that surrounds the electric wire member 20.

The electric wire member 20 includes k electric wires 21 (k is a natural number greater than or equal to 3) and a tubular braided member 25 that covers the k electric wires 21. The electric wire member 20 of the present embodiment has three electric wires 21, namely, electric wires 21a, 21b, and 21c. One end of each electric wire 21 is connected to the inverter 11 shown in FIG. 1, and the other end of each electric wire 21 is connected to the high-voltage battery 12 shown in FIG. 1. Each electric wire 21 is a high-voltage electric wire capable of handling high voltage and large current, for example.

### Configuration of Electric Wire 21

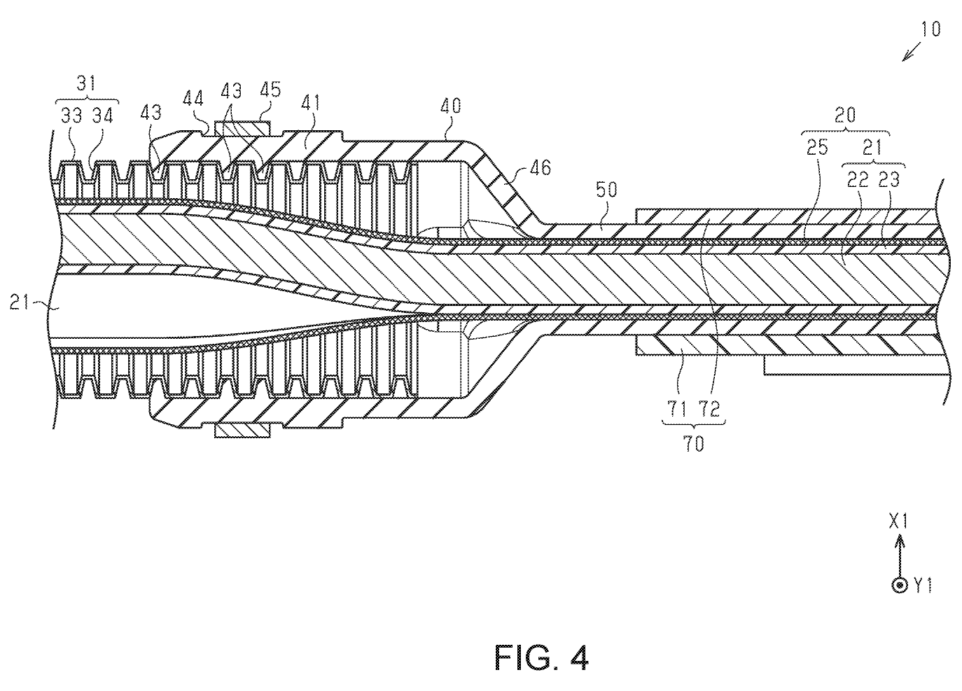

As shown in FIGS. 4 to 6, each electric wire 21 is a coated electric wire that has a core wire 22 made of a conductor and an insulating coating 23 the core wire 22.

The core wire 22 may be a stranded wire made of a plurality of metal wires stranded together or a single core wire made of a single conductor, for example. The single core wire may be a columnar conductor made of a single metal rod having a solid interior structure or a tubular conductor having a hollow interior structure, for example. The core wire 22 may be any combination of a stranded wire, a columnar conductor, and a tubular conductor. The material of the core wire 22 may be a copper-based or aluminum-based metal material, for example.

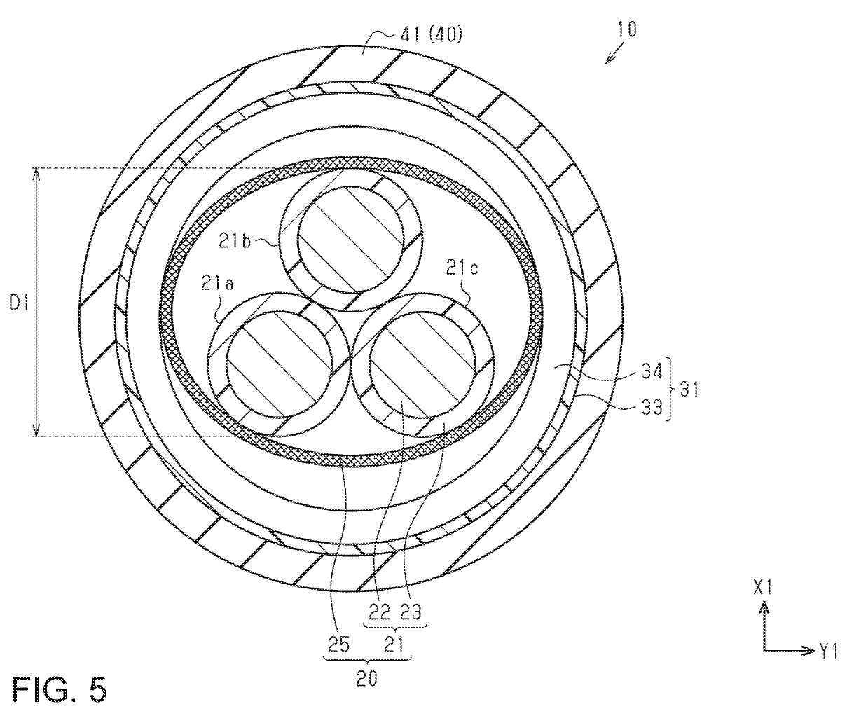

As shown in FIG. 5, the insulating coating 23 entirely surrounds the core wire 22 in the circumferential direction, for example. The insulating coating 23 is made of a resin material having insulating properties, for example.

The cross-sectional shape of each electric wire 21 cut by a plane orthogonal to the length direction of the electric wire 21, that is, the transverse cross-sectional shape of each electric wire 21, can be any shape. The transverse cross-sectional shape of each electric wire 21 can be a circular shape, a semicircular shape, a polygonal shape, a square shape, or a flat shape, for example. The transverse cross-sectional shape of each electric wire 21 in the present embodiment is a circular shape. In this specification, the term "flat shape" means a shape that is flat as a whole, and is a shape with a larger dimension in one direction, such as a rectangle, an oval, or an ellipse. In this specification, the term "rectangle" means a shape that has long sides and short sides, and does not include a square.

The braided member 25 is formed in a tubular shape that surrounds all of the electric wires 21, for example. The braided member 25 entirely surrounds the plurality of electric wires 21 in the circumferential direction, for example. Portions of the inner periphery of the braided member 25 are in contact with the outer peripheral surfaces of the plurality of electric wires 21, for example. The braided member 25 has flexibility, for example. The braided member 25 may be a braided wire in which a plurality of metal wires are woven, or a braided wire in which metal wires and resin wires are combined and woven, for example. The material of the metal wires may be a copper-based or aluminum-based metal material, for example. The ends of the braided member 25 in the length direction are connected to a grounding member (not shown) such as a vehicle body or a metal case. The braided member 25 functions as an electromagnetic shield member.

### Configuration of Tubular Member 30

As shown in FIGS. 2 and 3, the tubular member 30 is formed in an elongated tubular shape as a whole. The electric wire member 20 is stored in the internal space of the tubular member 30. The tubular member 30 has a function of protecting the internally stored electric wire member 20 from flying objects and water droplets, for example.

The tubular member 30 includes a corrugated tube 31, a corrugated tube 32, a waterproof member 40 (waterproof cover), and a path restriction member 70 (path restrictor), for example. The corrugated tubes 31 and 32 are made of synthetic resin, for example. The material of the corrugated tubes 31 and 32 may be a resin material having electrical conductivity or a resin material having no electrical conductivity, for example. The resin material may be a synthetic resin such as polyolefin, polyamide, polyester, or ABS resin, for example. The material of the waterproof member 40 may be an elastic material, for example. The elastic material may be a rubber such as ethylene propylene diene rubber (EPDM) or an elastomer, for example.

### Configuration of Corrugated Tubes 31 and 32

The corrugated tube 31 is coupled to the waterproof member 40. The corrugated tube 32 is coupled to the waterproof member 40. The corrugated tubes 31 and 32 have the same structure. Therefore, the structure of the corrugated tube 31 will be described here, and detailed description of the corrugated tube 32 will be omitted. FIGS. 2 and 3 show the corrugated tubes 31 and 32 and the braided member 25 with fracture cross sections.

The corrugated tube 31 is formed in a cylindrical shape that surrounds the entire outer periphery of the electric wire member 20 in the circumferential direction, for example. As shown in FIG. 4, the corrugated tube 31 has a bellows structure in which annular convex portions 33 and annular concave portions 34 are alternately and continuously provided along the axial direction of the corrugated tube 31. The axial direction of the corrugated tube 31 here is a direction extending along the central axis of the corrugated tube 31. As shown in FIG. 5, the corrugated tube 31 has a planar shape that is a perfect circle in the axial direction of the corrugated tube 31. That is, the transverse cross-sectional shape of the corrugated tube 31 is formed in a perfect circle.

### Configuration of Waterproof Member 40

As shown in FIG. 3, the waterproof member 40 is provided between the corrugated tube 31 and the corrugated tube 32. The waterproof member 40 is provided so as to extend between an end portion of the corrugated tube 31 and an end portion of the corrugated tube 32. A first end portion of the waterproof member 40 in the axial direction (here, the end portion on the left side of the drawing) covers the end portion of the corrugated tube 31, and a second end portion of the waterproof member 40 in the axial direction (here, the end portion on the right side of the drawing) covers the end portion of the corrugated tube 32. The axial direction of the waterproof member 40 here is the direction extending along the central axis of the waterproof member 40. The waterproof member 40 is formed in a tubular shape that completely surrounds the electric wire member 20 in the circumferential direction, for example.

The waterproof member 40 has connecting tube parts 41 and 42 (connecting tube), and a flat tube part 50 (flat tube) provided between the connecting tube part 41 and the connecting tube part 42, for example. The waterproof member 40 is a single component in which the connecting tube part 41, the flat tube part 50, and the connecting tube part 42 are continuously and integrally formed, for example. The waterproof member 40 is a resin molded article formed using a molding die, for example.

### Configuration of Connecting Tube Parts 41 and 42

The connecting tube part 41 is provided at the first end portion of the waterproof member 40 in the axial direction. The connecting tube part 41 is connected to an end portion of the corrugated tube 31. The connecting tube part 42 is provided at the second end portion of the waterproof member 40 in the axial direction. The connecting tube part 42 is connected to an end portion of the corrugated tube 32. The connecting tube parts 41 and 42 have the same structure. Therefore, the structure of the connecting tube part 41 will be described here, and detailed description of the connecting tube part 42 will be omitted.

As shown in FIG. 5, the connecting tube part 41 is formed in a cylindrical shape of a size that can be fitted to the outer periphery of the corrugated tube 31. The connecting tube part 41 is formed in a perfect circle in a plan view in the axial direction of the waterproof member 40. That is, the transverse cross-sectional shape of the connecting tube part 41 is formed in a perfect circle. The connecting tube part 41 is formed so as to be able to be in close contact with the outer peripheral surfaces of the annular convex portions 33 of the corrugated tube 31. The connecting tube part 41 tightens the corrugated tube 31 with a tensioning force from the outer peripheral side in order to keep water tightness. In this structure, since the connecting tube part 41 and the corrugated tube 31 are both formed in a perfect circle, a tensioning force can be uniformly applied from the connecting tube part 41 to the entire periphery of the corrugated tube 31 in the circumferential direction. Accordingly, water tightness between the connecting tube part 41 and the corrugated tube 31 can be kept in a suitable manner. As a result, it is possible to suppress the intrusion of water into the waterproof member 40 and the corrugated tube 31 from between the connecting tube part 41 and the corrugated tube 31.

As shown in FIG. 4, the inner peripheral surface of the connecting tube part 41 has one or more lips 43 (three in the present embodiment) that engage with the corrugated tube 31, for example. Each lip 43 is formed continuously around the entire inner peripheral surface of the connecting tube part 41 in the circumferential direction, and is formed in an endless structure in which the start point and the end portion point coincide, for example. Each lip 43 is formed so as to enter the annular concave portions 34 of the corrugated tube 31 when the connecting tube part 41 is fitted onto the outer periphery of the corrugated tube 31, for example.

The connecting tube part 41 has a groove-shaped fixing part 44 formed on its outer peripheral surface. The fixing part 44 is formed continuously around the entire outer peripheral surface of the connecting tube part 41 in the circumferential direction, for example. The fixing part 44 has a coupling member 45, for example. The coupling member 45 may be a banding band or a crimping ring made of resin or metal, for example. The connecting tube part 41 is tightened from the outer peripheral side by the coupling member 45 and firmly fixed to the corrugated tube 31, for example. This can suitably prevent the corrugated tube 31 from detaching from the connecting tube part 41.

The corrugated tube 31 is inserted only into the connecting tube part 41 of the waterproof member 40. In other words, the corrugated tube 31 is not inserted into the flat tube part 50 of the waterproof member 40.

As shown in FIG. 5, inside the connecting tube part 41 and the corrugated tube 31, three electric wires 21a, 21b, and 21c are arranged in n tiers (n is a natural number less than or equal to k–1 and greater than or equal to 2), here in two tiers, in a first direction X1 orthogonal to the axial direction of the waterproof member 40. In the present embodiment, inside the connecting tube part 41, the three electric wires 21a, 21b, and 21c are arranged in a bale-stacking manner (pyramid shape). For example, inside the connecting tube part 41, the three electric wires 21a, 21b, and 21c are arranged so as to draw a substantially equilateral triangle when the centers of the core wires 22 are connected. Specifically, inside the connecting tube part 41, among the three electric wires 21a, 21b, and 21c, two electric wires 21a and 21c are arranged side by side along a second direction Y1 orthogonal to both the axial direction of the waterproof member 40 and the first direction X1. These two electric wires 21a and 21c are arranged such that their outer peripheral surfaces are partially in contact with each other, for example. Inside the connecting tube part 41, the remaining electric wire 21b of the three electric wires 21a, 21b, 21c is stacked on top of the two electric wires 21a and 21c aligned in the second direction Y1. That is, the remaining electric wire 21b is stacked on top of the two electric wires 21a and 21c aligned in the second direction Y1, in the first direction X1 orthogonal to both the axial direction of the waterproof member 40 and the second direction Y1. The remaining electric wire 21b is arranged so as to be partially in contact with the outer peripheral surfaces of both the two electric wires 21a and 21c aligned in the second direction Y1.

Inside the connecting tube part 41 and the corrugated tube 31, the braided member 25 is formed to collectively surround the three electric wires 21a, 21b, and 21c arranged in a bale-stacking manner. In this structure, the inner peripheral surface of the braided member 25 is in partial contact with the outer peripheral surfaces of the three electric wires 21a, 21b, and 21c, for example. In addition, the outer peripheral surface of the braided member 25 is in partial contact with the inner peripheral surfaces of the annular concave portions 34 of the corrugated tube 31, for example.

### Configuration of Flat Tube part 50

As shown in FIG. 3, the flat tube part 50 is formed to extend from the connecting tube part 41 to the connecting tube part 42.

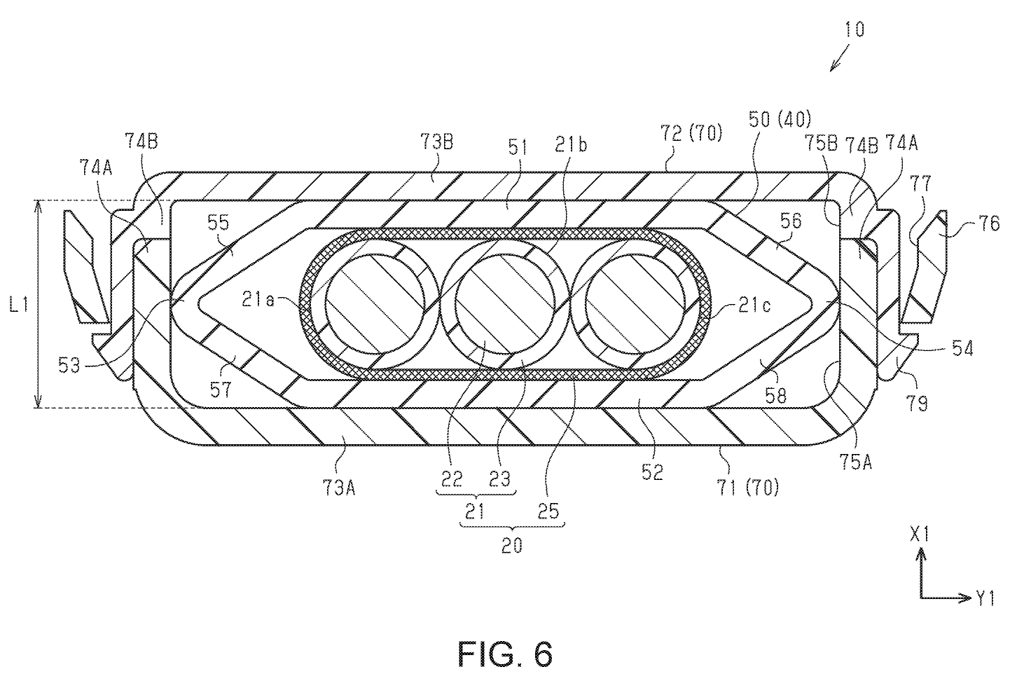

As shown in FIG. 6, the flat tube part 50 has a flat planar shape when viewed in the axial direction of the waterproof member 40. That is, the transverse cross-sectional shape of the flat tube part 50 is a flat shape. Specifically, the transverse cross-sectional shape of the flat tube part 50 is a flat shape in which the dimension along the second direction Y1 is larger than the dimension along the first direction X1.

The transverse cross-sectional shape of the flat tube part 50 has two long side portions 51 and 52 extending along the second direction Y1 which is the longitudinal direction, two intermediate portions 53 and 54 provided between the two long side portions 51 and 52 in the first direction X1, and four inclined portions 55, 56, 57, and 58. The transverse cross-sectional shape of the flat tube part 50 is formed into a hexagonal shape as a whole.

The two long side portions 51 and 52 extend horizontally along the second direction Y1. The two long side portions 51 and 52 are formed so as to extend parallel to each other. The two long side portions 51 and 52 are provided so as to face each other in the first direction X1.

The two intermediate portions 53 and 54 are provided so as to face each other in the second direction Y1. The intermediate portions 53 and 54 are provided in positions outward of the long side portions 51 and 52 in the second direction Y1. The intermediate portions 53 and 54 have point-like shapes, for example. The outer surfaces of the intermediate portions 53 and 54 are formed in a curved surface that is curved in an arc shape.

The four inclined portions 55, 56, 57, and 58 connect both end portions of the two long side portions 51 and 52 and the two intermediate portions 53 and 54. The inclined portion 55 connects the long side portion 51 and the intermediate portion 53. The inclined portion 56 connects the long side portion 51 and the intermediate portion 54. The inclined portion 57 connects the long side portion 52 and the intermediate portion 53. The inclined portion 58 connects the long side portion 52 and the intermediate portion 54. The inclined portions 55, 56, 57, and 58 extend along an oblique direction that intersects both the first direction X1 and the second direction Y1 in the transverse cross section. In more detail, the inclined portions 55 and 58 extend along a first oblique direction intersecting both the first direction X1 and the second direction Y1 in the transverse cross section. The inclined portions 56 and 57 extend in a second oblique direction that intersects both the first direction X1 and the second direction Y1 and that intersects the first oblique direction in the transverse cross section. The length of the inclined portions 55, 56, 57, and 58 is shorter than the length of the long side portions 51 and 52.

As shown in FIG. 4, the flat tube part 50 is formed to be smaller in size than the connecting tube part 41 in the first direction X1, for example. That is, the dimension of the flat tube part 50 along the first direction X1 is smaller than the dimension of the connecting tube part 41 along the first direction X1. The connecting tube part 41 is formed to protrude in the first direction X1 beyond the outer peripheral surface of the flat tube part 50.

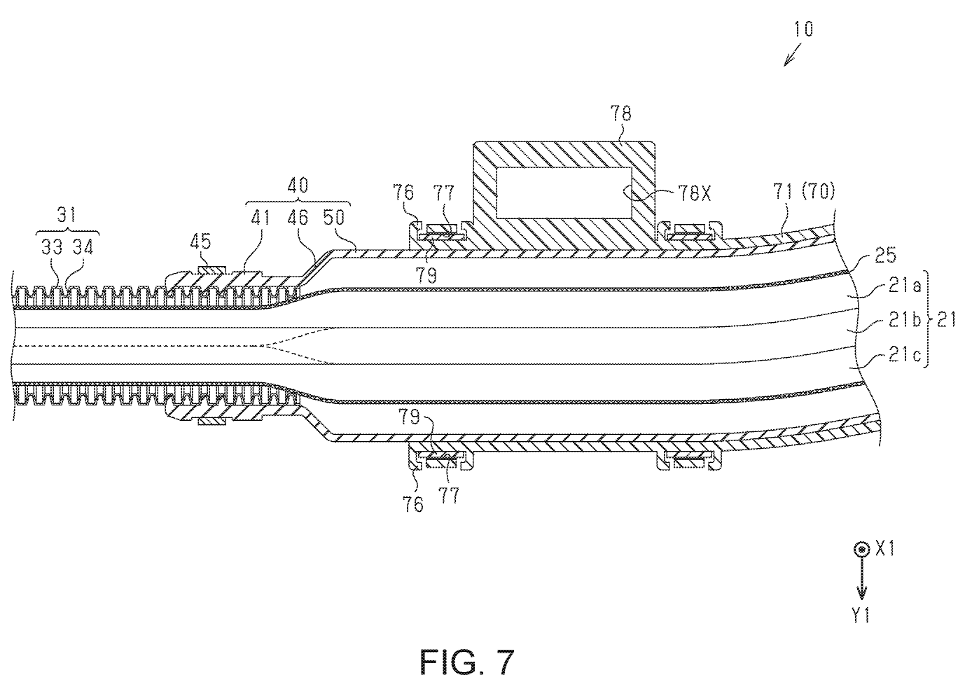

As shown in FIG. 7, the flat tube part 50 is formed to be larger in size than the connecting tube part 41 in the second direction Y1. The dimension of the flat tube part 50 along the second direction Y1 is larger than the dimension of the connecting tube part 41 along the second direction Y1.

The waterproof member 40 has a coupling tube part 46 that couples the connecting tube part 41 and the flat tube part 50. The coupling tube part 46 is formed such that the inner diameter and the outer diameter decrease from the flat tube part 50 toward the connecting tube part 41 in the second direction Y1. As shown in FIG. 4, the coupling tube part 46 is formed such that the inner diameter and the outer diameter increase from the flat tube part 50 toward the connecting tube part 41 in the first direction X1.

As shown in FIG. 6, inside the flat tube part 50, the three electric wires 21a, 21b, and 21c are arranged in m tiers (m is a natural number less than or equal to n–1) in the first direction X1, here in one tier. In the present embodiment, inside the flat tube part 50, the three electric wires 21a, 21b, and 21c are arranged side by side along the second direction Y1. That is, inside the flat tube part 50, the three electric wires 21a, 21b, and 21c are arranged side by side along the second direction Y1. The three electric wires 21a, 21b, and 21c are arranged such that the outer peripheral surfaces of two adjacent electric wires 21 are partially in contact with each other, for example.

Inside the flat tube part 50, the braided member 25 is formed so as to collectively surround the three electric wires 21a, 21b, and 21c arranged side by side. In this structure, the transverse cross-sectional shape of the braided member 25 is formed in a flat shape. In the present embodiment, the transverse cross-sectional shape of the braided member 25 inside the flat tube part 50 is formed in an elliptical shape. Inside the flat tube part 50, the inner peripheral surface of the braided member 25 is in partial contact with the outer peripheral surfaces of the three electric wires 21, for example. The outer peripheral surface of the braided member 25 is in contact with the inner peripheral surface of the flat tube part 50, specifically, the inner peripheral surfaces of the long side portions 51 and 52, for example. The outer peripheral surface of the braided member 25 is in contact with the inner peripheral surfaces of the long side portions 51 and 52 along the second direction Y1, for example.

As described above, the arrangement of the three electric wires 21 is different between the inside of the connecting tube part 41 (see FIG. 5) whose transverse cross-sectional shape is formed in a perfect circle and the inside of the flat tube part 50 whose transverse cross-sectional shape is formed in a flat shape. Specifically, as shown in FIG. 7, the arrangement of the three electric wires 21 in a bale-stacking manner inside the connecting tube part 41 is changed to the horizontal arrangement along the second direction Y1 inside the flat tube part 50.

### Configuration of Path Restriction Member 70

As shown in FIG. 2, the path restriction member 70 is attached to the outer periphery of the waterproof member 40. The path restriction member 70 is provided so as to cover the outer periphery of the flat tube part 50 of the waterproof member 40. The path restriction member 70 is provided so as to expose the connecting tube parts 41 and 42 of the waterproof member 40. The path restriction member 70 restricts the path of the electric wire member 20. The path restriction member 70 is formed in a shape along a desired path of the electric wire member 20, for example. The path restriction member 70 acts to make the portions of the electric wire member 20 and the waterproof member 40 less likely to bend than the portions of the electric wire member 20 and the waterproof member 40 to which the path restriction member 70 is not attached, thereby suppressing deviation of the electric wire member 20 from the desired path. The path restriction member 70 is harder than the waterproof member 40, for example. The path restriction member 70 is hard and more difficult to bend in a direction orthogonal to the length direction of the wire harness 10 as compared to the waterproof member 40.

The path restriction member 70 has a bent shape in a plan view seen in the first direction X1, for example. The path restriction member 70 also has a bent shape that rises in the first direction X1, for example.

The path restriction member 70 is formed in a flat tubular shape as a whole, for example. As shown in FIG. 6, the transverse cross-sectional shape of the path restriction member 70 is formed in a rectangular shape that is longer in the second direction Y1 than in the first direction X1.

As shown in FIG. 3, the path restriction member 70 is constituted of a plurality of divided bodies (two in the present embodiment), that is, a first divided body 71 and a second divided body 72, for example. The first divided body 71 and the second divided body 72 are separate parts, for example. The first divided body 71 and the second divided body 72 are formed to be attachable to and detachable from each other. The path restriction member 70 is formed into a tubular shape that surrounds the outer periphery of the flat tube part 50 of the waterproof member 40 by combining the first divided body 71 and the second divided body 72. The first divided body 71 is assembled to the second divided body 72 along the first direction X1. The first divided body 71 and the second divided body 72 extend along the axial direction of the waterproof member 40. In other words, the axial direction of the path restriction member 70 coincides with the axial direction of the waterproof member 40. The axial direction of the path restriction member 70 here is the direction in which the central axis of the path restriction member 70 extends.

The first divided body 71 and the second divided body 72 are made of a synthetic resin, for example. The material of the first divided body 71 and the second divided body 72 can be a synthetic resin such as polyolefin, polyamide, polyester, or ABS resin, for example. The materials of the first divided body 71 and the second divided body 72 may be the same type of material or different materials.

### Configuration of First Divided Body 71

As shown in FIG. 6, the first divided body 71 is formed in a semi-tubular shape as a whole, for example. The first divided body 71 is formed in a semi-tubular shape that partially covers the outer periphery of the waterproof member 40 in the circumferential direction of the waterproof member 40, for example. The transverse cross-sectional shape of the first divided body 71 is formed in a U-shape as a whole.

The first divided body 71 has a first bottom wall 73A that faces the second divided body 72 and two first side walls 74A that protrude from both side edges of the first bottom wall 73A toward the second divided body 72, for example. The first bottom wall 73A is formed in a plate shape. The first bottom wall 73A has a thickness in the first direction X1 and has a width in the second direction Y1.

The first side walls 74A are formed so as to be continuous from and integral with the first bottom wall 73A. The first side walls 74A protrude from both end portions of the first bottom wall 73A in the width direction (here, the second direction Y1) toward the first direction X1, for example. The first side walls 74A face each other in the second direction Y1, for example. The first side walls 74A are formed in a plate shape. The first side walls 74A have a thickness in the second direction Y1 and have a height in the first direction X1. The first side walls 74A extend over the entire length of the first bottom wall 73A in the length direction.

The first divided body 71 has a first storage convex portion 75A. The first storage convex portion 75A constitutes an internal space of the path restriction member 70 in a state where the first divided body 71 and the second divided body 72 are combined. The first storage convex portion 75A is formed so as to be recessed from the end face of the first divided body 71 in the first direction X1 toward the first bottom wall 73A, for example. The first storage convex portion 75A is constituted by the inner surface of the first bottom wall 73A and the inner surfaces of the two first side walls 74A. As shown in FIG. 3, the first storage convex portion 75A is open in the first direction X1 and also open in the axial direction of the path restriction member 70. The first storage convex portion 75A extends over the entire length of the path restriction member 70 along the axial direction of the path restriction member 70.

The first divided body 71 has a plurality of first engagement portions 76, for example. The plurality of first engagement portions 76 are provided at intervals along the axial direction of the path restriction member 70. The first engagement portions 76 are formed so as to protrude outward from the outer surface of the first side walls 74A. As shown in FIG. 7, the first engagement portions 76 are engagement frame portions, for example. Each first engagement portion 76 is shaped a rectangular frame body, for example, and has an engagement hole 77 in the center of the frame body.

The first divided body 71 has one or more fixing parts 78 (two in the present embodiment), for example. The fixing parts 78 are members for fixing the path restriction member 70 to the vehicle body, for example. Each fixing part 78 has an insertion hole 78X that passes through the fixing part 78 in the first direction X1, for example. A fixing device (not shown) provided on the vehicle body is inserted into the insertion hole 78X, for example. This allows the path restriction member 70 to be fixed to the vehicle body. An example of the fixing device may be a bracket.

### Configuration of Second Divided Body 72

As shown in FIG. 6, the second divided body 72 is formed in a semi-tubular shape as a whole, for example. The second divided body 72 has a structure similar to that of the first divided body 71, for example. For this reason, the parts of the second divided body 72 in common with the first divided body 71 are given reference numerals in which the suffix "A" of the reference numerals of the corresponding parts of the first divided body 71 is changed to "B", and detailed descriptions thereof will be omitted.

The second divided body 72 has a second bottom wall 73B that faces the first bottom wall 73A and two second side walls 74B that protrude from both side edges of the second bottom wall 73B toward the first divided body 71. The second divided body 72 has a second storage convex portion 75B formed by the inner surface of the second bottom wall 73B and the inner surfaces of the two second side walls 74B. The second storage convex portion 75B constitutes an internal space of the path restriction member 70 in a state where the first divided body 71 and the second divided body 72 are combined. That is, in a state where the first divided body 71 and the second divided body 72 are combined, the first storage convex portion 75A and the second storage convex portion 75B are overlapped to form the internal space of the path restriction member 70 in which the flat tube part 50 of the waterproof member 40 is to be stored. In a state where the first divided body 71 and the second divided body 72 are combined together, the front end face of the first side wall 74A and the front end face of the second side wall 74B are in contact with each other.

As shown in FIG. 3, the second divided body 72 has a plurality of second engagement portions 79. The plurality of second engagement portions 79 are provided at intervals along the axial direction of the path restriction member 70. The second engagement portions 79 are provided so as to face the first engagement portions 76 of the first divided body 71. The second engagement portions 79 are provided on the second side walls 74B. The second engagement portions 79 are elastic pieces that are elastically deformable and protrude from the front side faces of the second side walls 74B toward the first divided body 71. As shown in FIG. 6, the second engagement portions 79 are engaged with the engagement holes 77 of the first engagement portions 76. The first engagement portions 76 and the second engagement portions 79 are engaged with each other, for example, by a snap-fit method that utilizes the elastic deformation of the second engagement portions 79.

The first divided body 71 and the second divided body 72 are assembled together along the first direction X1. The first divided body 71 and the second divided body 72 are combined by overlapping the first storage convex portion 75A and the second storage convex portion 75B, for example. The first divided body 71 and the second divided body 72 are combined with the flat tube part 50 interposed therebetween. The first divided body 71 and the second divided body 72 are combined such that the first engagement portions 76 and the second engagement portions 79 are engaged with each other. The combined state of the first divided body 71 and the second divided body 72 is maintained by the engagement of the first engagement portions 76 and the second engagement portions 79. In a state where the first divided body 71 and the second divided body 72 are combined, the path restriction member 70 is formed in a tubular shape that covers the outer periphery of the flat tube part 50. In addition, in a state where the first divided body 71 and the second divided body 72 are combined, the flat tube part 50 is stored in the internal space of the path restriction member 70 in a state where it is compressed in the first direction X1, for example. Specifically, the path restriction member 70 compresses the flat tube part 50 in the first direction X1 such that the k electric wires 21 are arranged in m tiers inside the flat tube part 50. The path restriction member 70 in the present embodiment compresses the flat tube part 50 in the first direction X1 such that the three electric wires 21 are arranged side-by-side along the second direction Y1 inside the flat tube part 50. In other words, the size of the internal space of the path restriction member 70 is set so as to compress the flat tube part 50 in the first direction X1. For example, the dimension of the internal space of the path restriction member 70 along the first direction X1 is set to be smaller than the dimension of the flat tube part 50 along the first direction X1 to which the path restriction member 70 is not yet attached.

A first distance L1 between the first bottom wall 73A and the second bottom wall 73B along the first direction X1 is smaller than a first dimension D1 along the first direction X1 of the k (here, three) electric wires 21 arranged in n tiers (here, two tiers) shown in FIG. 5. The first dimension D1 here is the maximum dimension along the first direction X1 among the outer dimensions of the electric wire bundle constituted of the three electric wires 21. Also, as shown in FIG. 6, the first distance L1 is the shortest distance along the first direction X1 between the inner surface of the first bottom wall 73A and the inner surface of the second bottom wall 73B. If the first distance L1 is set as described above and the first divided body 71 and the second divided body 72 are combined, the three electric wires 21 cannot maintain the n-tier arrangement inside the path restriction member 70, so that the three electric wires 21 are changed to an m-tier arrangement.

### Method for Manufacturing Wire Harness 10

Next, an example of a method for manufacturing the wire harness 10 will be described.

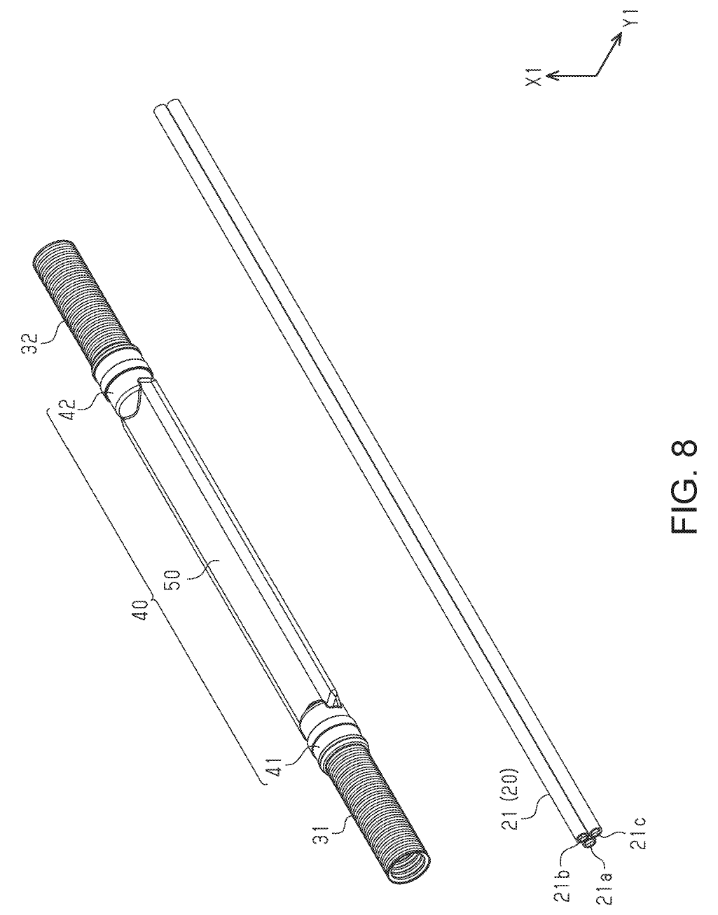

First, as shown in FIG. 8, a first structural body is formed in which the corrugated tube 31, the waterproof member 40, and the corrugated tube 32 are coupled together. Specifically, the first structural body is formed in which the connecting tube part 41 of the waterproof member 40 is connected to the outer periphery of an end portion of the corrugated tube 31, and the connecting tube part 42 of the waterproof member 40 is connected to the outer periphery of an end portion of the corrugated tube 32. At this time, the flat tube part 50 of the waterproof member 40 is not yet formed into a bent shape but is formed so as to extend in a straight linear shape, for example.

Next, the electric wire member 20 is inserted into the inside of the first structural body. In this routing work of the electric wire member 20, it is easier to route the three electric wires 21 arranged in a bale-stacking manner than the three electric wires 21 arranged side by side. However, if the waterproof member 40 is provided with the flat tube part 50, it is difficult to route the three electric wires 21 arranged in a bale-stacking manner through the flat tube part 50 in a flat state.

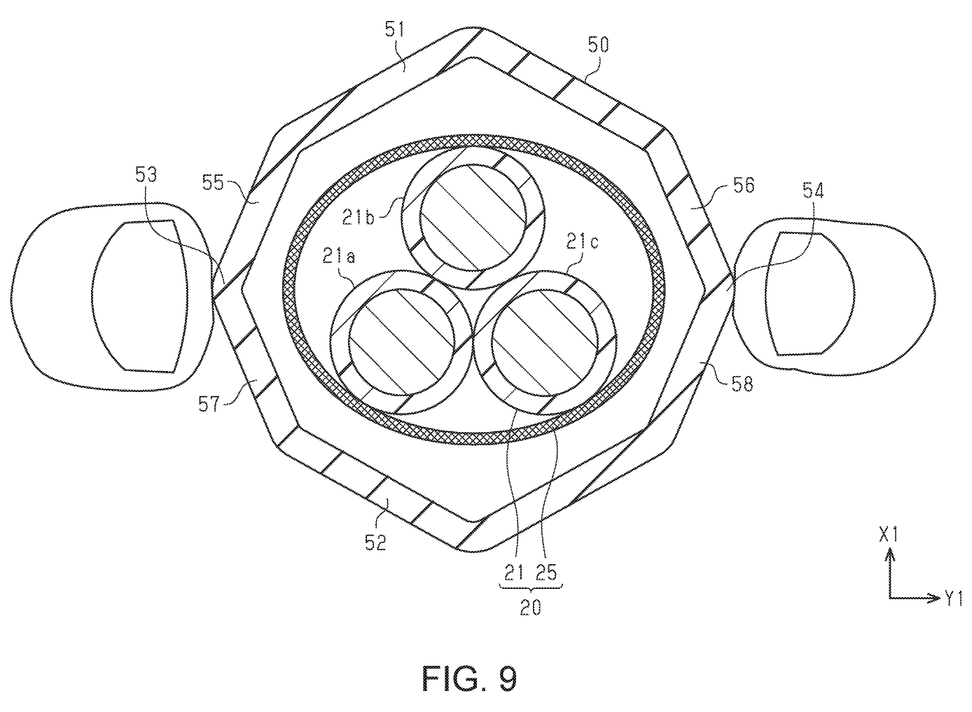

Therefore, as shown in FIG. 9, in the present embodiment, the three electric wires 21 are routed inside the flat tube part 50 in a state where the flat tube part 50 is deformed toward a perfect circular shape. By routing the electric wires 21 while deforming the flat tube part 50 as described above, the routing can be performed in a state in which the three electric wires 21 are arranged in a bale-stacking manner. The flat tube part 50 is pressed such that the two intermediate portions 53 and 54 approach each other by the fingers or the like of the worker performing the routing work, so that the flat tube part 50 becomes deformed such that the dimension along the second direction Y1 becomes smaller and the dimension along the first direction X1 becomes larger. In this case, the transverse cross-sectional shape of the flat tube part 50 is different from an elliptical shape, and the end portions in the second direction Y1 are formed into point-like intermediate portions 53 and 54. Accordingly, the point-like intermediate portions 53 and 54 can be suitably pressed by the fingers or the like of the worker. In addition, since the end portions of the flat tube part 50 in the second direction Y1 are formed into the point-like intermediate portions 53 and 54, the point-like intermediate portions 53 and 54 can be starting points from which the flat tube part 50 spreads in the first direction X1 when being pressed by fingers or the like. Further, in the flat tube part 50, the inclined portions 55, 56, 57, and 58, which obliquely extend from the intermediate portions 53 and 54 so as to spread outward in the first direction X1, are formed shorter than the long side portions 51 and 52. Accordingly, when the intermediate portions 53 and 54 are pressed by fingers or the like, the long side portions 51 and 52 can be deformed more easily than the inclined portions 55, 56, 57, and 58, so that the flat tube part 50 can be deformed suitably so as to spread in the first direction X1. Specifically, the transverse cross-sectional shape of the flat tube part 50 in this step is deformed such that the angle formed by the inclined portions 55 and 57 and the angle formed by the inclined portions 56 and 58 are widened, and the long side portions 51 and 52 are deformed so as to be bent midway. In this manner, the transverse cross-sectional shape of the flat tube part 50 in the present embodiment is deformed into an octagonal shape as a whole, which is closer to a perfect circle compared to the flat shape before deformation. The routing of the electric wire member 20 is performed in a state where the braided member 25 is attached to the outer periphery of the three electric wires 21.

Through the above steps, a structural body can be obtained in which the electric wire member 20 is inserted into the first structural body. After that, when the pressure from the fingers or the like is released, the flat tube part 50 attempts to return to the flat shape that is longer in the second direction Y1 than in the first direction X1. However, the arrangement of the three electric wires 21 may be maintained in a bale-stacking arrangement.

Subsequently, as shown in FIG. 3, the path restriction member 70 is attached to the outer periphery of the flat tube part 50 of the waterproof member 40. Specifically, the first divided body 71 and the second divided body 72 are combined together with the flat tube part 50 sandwiched therebetween. Then, the first engagement portions 76 of the first divided body 71 and the second engagement portions 79 of the second divided body 72 are engaged with each other to maintain the combined state of the first divided body 71 and the second divided body 72. In this case, as shown in FIG. 6, the first distance L1 along the first direction X1 between the first bottom wall 73A and the second bottom wall 73B is set to be smaller than the first dimension D1 along the first direction X1 of the three electric wires 21 arranged in two tiers as shown in FIG. 5. Therefore, when the first divided body 71 and the second divided body 72 are combined, the three electric wires 21 arranged in a bale-stacking manner are pressed in the first direction X1 by the first divided body 71 and the second divided body 72. Accordingly, inside the flat tube part 50, the three electric wires 21 arranged in a bale-stacking manner can be changed to a side-by-side arrangement. Therefore, the flat tube part 50 can be made suitably low-profile in the first direction X1. Also, as shown in FIG. 2, the path restriction member 70 is attached to the outer periphery of the flat tube part 50, so that the flat tube part 50 and the electric wire member 20 are formed in a shape similar to the bent shape of the path restriction member 70.

Through the above manufacturing process, the wire harness 10 of the present embodiment can be manufactured.

### Operations and Advantageous Effects of Present Embodiment

Next, operations and advantageous effects of the present embodiment will be described.

(1) The wire harness 10 includes the electric wire member 20, the corrugated tube 31 that covers the outer periphery of the electric wire member 20, and the waterproof member 40 that covers the outer periphery of the electric wire member 20 and is coupled to the corrugated tube 31. The waterproof member 40 has the connecting tube part 41 that covers the outer periphery of the corrugated tube 31, and the flat tube part 50 that is formed integrally with the connecting tube part 41. The transverse cross-sectional shape of the corrugated tube 31 is formed in a perfect circular shape. The transverse cross-sectional shape of the connecting tube part 41 is formed in a perfect circular shape. The transverse cross-sectional shape of the flat tube part 50 is formed in a flat shape in which the dimension along the second direction Y1 orthogonal to the axial direction of the waterproof member 40 is larger than the dimension along the first direction X1 orthogonal to both the axial direction of the waterproof member 40 and the second direction Y1. The dimension of the flat tube part 50 along the first direction X1 is smaller than the dimension of the connecting tube part 41 along the first direction X1.

According to this configuration, the waterproof member 40 is formed in a structure having the connecting tube part 41 and the flat tube part 50. That is, a part of the waterproof member 40 is formed in the flat tube part 50. The flat tube part 50 is formed in a flat shape that is longer in the second direction Y1 than the first direction X1. The dimension of the flat tube part 50 along the first direction X1 is set to be smaller than the dimension of the connecting tube part 41 along the first direction X1. Therefore, the flat tube part 50 can be made more low-profile in the first direction X1 than the connecting tube part 41. Accordingly, a part of the waterproof member 40 can be made low-profile in the first direction X1, and thus a part of the wire harness 10 can be made low-profile in the first direction X1.

The transverse cross-sectional shape of the corrugated tube 31 is formed in a perfect circular shape, and the transverse cross-sectional shape of the connecting tube part 41 covering the outer periphery of the corrugated tube 31 is also a perfect circular shape. Therefore, compared with a case in which the transverse cross-sectional shape of either the corrugated tube 31 or the connecting tube part 41 is a flat shape, it is possible to apply a uniform tensioning force from the connecting tube part 41 to the entire periphery of the corrugated tube 31 in the circumferential direction. This makes it possible to preferably maintain the water-tightness between the corrugated tube 31 and the connecting tube part 41, and therefore to preferably stop water leakage between the corrugated tube 31 and the connecting tube part 41. Therefore, it is possible to preferably prevent deterioration of the water-stopping property between the corrugated tube 31 and the waterproof member 40 while making low-profile a part of the wire harness 10.

(2) The path restriction member 70 capable of restricting the path of the electric wire member 20 is attached to the outer periphery of the flat tube part 50. Accordingly, even if the waterproof member 40 alone has low rigidity, for example, the path of the electric wire member 20 can be suitably restricted by the path restriction member 70.

(3) The electric wire member 20 has k electric wires 21 (here, three electric wires). The three electric wires 21 are arranged in n tiers (here, two tiers) in the first direction X1 inside the connecting tube part 41. The three electric wires 21 are arranged in m tiers (here, one tier) in the first direction X1 inside the flat tube part 50. The path restriction member 70 compresses the flat tube part 50 in the first direction X1 such that the three electric wires 21 are arranged side by side along the second direction Y1 inside the flat tube part 50.

According to this configuration, the flat tube part 50 is compressed in the first direction X1 by the path restriction member 70, so that the three electric wires 21 can be arranged side by side along the second direction Y1 inside the flat tube part 50. Accordingly, the three electric wires 21 can be arranged in a single tier in the first direction X1 inside the flat tube part 50, so that the flat tube part 50 can be suitably made low-profile in the first direction X1.

(4) The path restriction member 70 has the first divided body 71 and the second divided body 72 that is formed to be capable of combining with the first divided body 71. The path restriction member 70 is formed into a tubular shape that surrounds the outer periphery of the flat tube part 50 by combining the first divided body 71 and the second divided body 72.

According to this configuration, the path restriction member 70 is formed into a tubular shape that surrounds the flat tube part 50 by the first divided body 71 and the second divided body 72. Accordingly, while the path restriction member 70 is formed in a tubular shape, the path restriction member 70 is divided into the first divided body 71 and the second divided body 72, so that the path restriction member 70 can be attached afterward to the electric wire member 20 and the flat tube part 50. This improves the ease of assembly of the path restriction member 70.

(5) The first divided body 71 has the first bottom wall 73A. The second divided body 72 has the second bottom wall 73B that faces the first bottom wall 73A in the first direction X1. The first distance L1 between the first bottom wall 73A and the second bottom wall 73B in the first direction X1 is shorter than the first dimension D1 in the first direction X1 of the three electric wires 21 arranged in two tiers. According to this configuration, even if the three electric wires 21 arranged in a bale-stacking manner are inserted into the flat tube part 50, attaching the path restriction member 70 afterward to the flat tube part 50 allows the three electric wires 21 to be suitably changed to a side-by-side arrangement inside the flat tube part 50. Accordingly, it is possible to preferably make the flat tube part 50 low-profile in the first direction X1.

(6) The first divided body 71 has the first engagement portions 76. The second divided body 72 has the second engagement portions 79 that engage with the first engagement portions 76. In the path restriction member 70, the first engagement portions 76 and the second engagement portions 79 are engaged with each other to maintain the combined state of the first divided body 71 and the second divided body 72.

According to this configuration, the combined state of the first divided body 71 and the second divided body 72 can be maintained by engaging the first engagement portions 76 of the first divided body 71 with the second engagement portions 79 of the second divided body 72. Therefore, the ease of assembly of the path restriction member 70 can be improved compared to a case in which the combined state of the first divided body 71 and the second divided body 72 is maintained using components separate from the first divided body 71 and the second divided body 72.

(7) The transverse cross-sectional shape of the flat tube part 50 has the two long side portions 51 and 52 that extend along the second direction Y1. The transverse cross-sectional shape of the flat tube part 50 has the two intermediate portions 53 and 54 that are provided between the two long side portions 51 and 52 in the first direction X1 and are provided outward of the long side portions 51 and 52 in the second direction Y1. The transverse cross-sectional shape of the flat tube part 50 has the four inclined portions 55, 56, 57, and 58 that connect both ends of the two long side portions 51 and 52 to the two intermediate portions 53 and 54. The two long side portions 51 and 52 face each other in the first direction X1. The two intermediate portions 53 and 54 face each other in the second direction Y1. The four inclined portions 55, 56, 57, and 58 extend along an oblique direction intersecting both the first direction X1 and the second direction Y1, and are formed shorter than the two long side portions 51 and 52.

According to this configuration, for example, when the flat tube part 50 is pressed such that the two intermediate portions 53 and 54 approach each other, the long side portions 51 and 52 can be deformed more easily than the inclined portions 55, 56, 57, and 58. Accordingly, the flat tube part 50 can be deformed so as to expand in the first direction X1. Therefore, when the flat tube part 50 is pressed such that the two intermediate portions 53 and 54 approach each other, the flat tube part 50 is deformed so as to become smaller in the second direction Y1 and larger in the first direction X1. As a result, the difference between the dimension of the flat tube part 50 in the second direction Y1 and the dimension of the flat tube part 50 in the first direction X1 can be reduced, and the transverse cross-sectional shape of the flat tube part 50 can be changed from a flat shape to a perfect circular shape. Therefore, during the routing work of inserting the electric wire member 20 into the waterproof member 40, the transverse cross-sectional shape of the flat tube part 50 can be deformed so as to become closer to a perfect circular shape. This makes it possible to, during the routing work of the electric wire member 20, insert the three electric wires 21 into the inside of the flat tube part 50 in a state of being arranged in a bale-stacking manner, for example, thereby improving the ease of routing the electric wire member 20. As a result, the ease of assembling the wire harness 10 can be improved.

### Modifications

The above-described embodiments can be modified as described below. The above-described embodiments and the following modifications can be combined with each other to the extent that no technical contradiction occurs.

The structure of the flat tube part 50 of the waterproof member 40 in the above-described embodiments may be modified as appropriate.

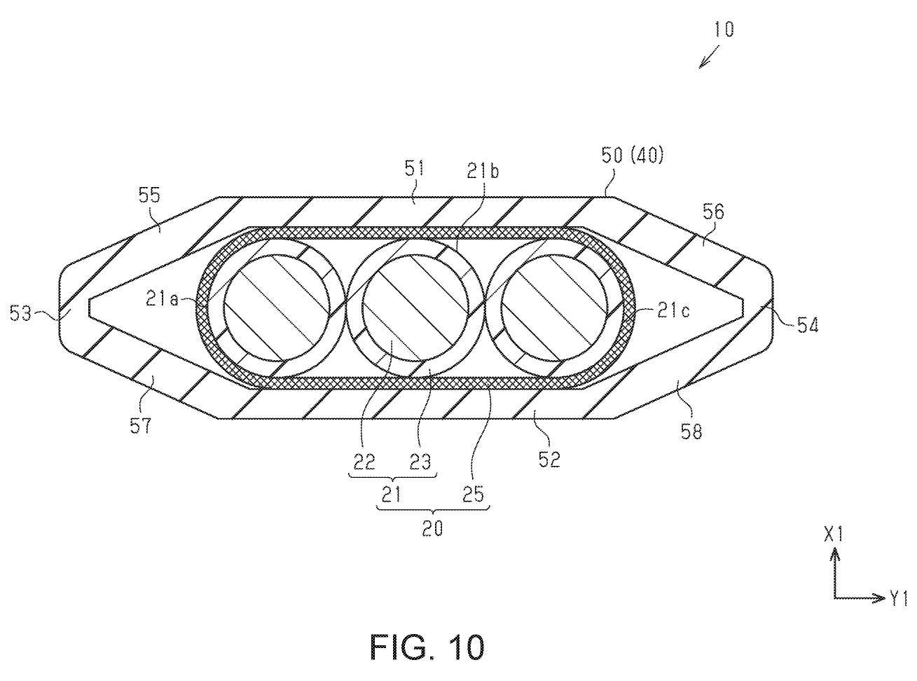

For example, as shown in FIG. 10, intermediate portions 53 and 54 may be formed so as to extend along a first direction X1. In this case, the transverse cross-sectional shape of a flat tube part 50 is formed into an octagonal shape as a whole. According to this configuration, compared to the case where the intermediate portions 53 and 54 are formed in a point-like shape, it is possible to suppress the formation of burrs on intermediate portions 53 and 54 during resin molding using a molding die.

For example, as shown in FIG. 10, the thickness of inclined portions 55, 56, 57, and 58 may be greater than the thickness of long side portions 51 and 52. According to this configuration, the rigidity of the inclined portions 55, 56, 57, and 58 can be made higher than the rigidity of the long side portions 51 and 52. Accordingly, in deforming the flat tube part 50 during the routing of an electric wire member 20, it is possible to suppress the bending of the inclined portions 55, 56, 57, and 58, and make the long side portions 51 and 52 easier to bend than the inclined portions 55, 56, 57, and 58. As a result, the flat tube part 50 can be deformed preferably so as to expand in the first direction X1.

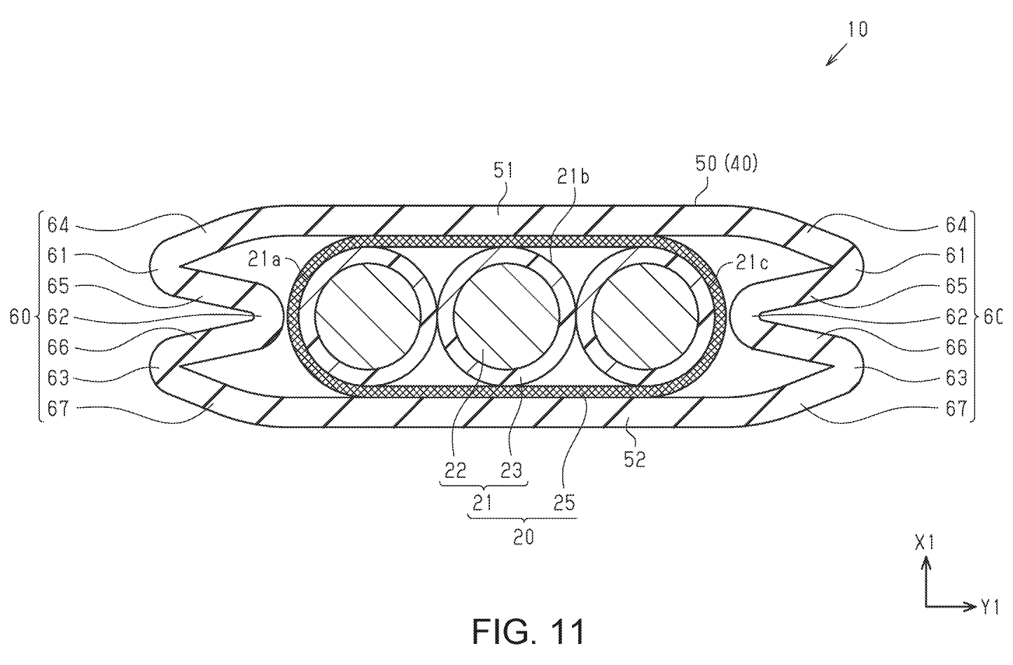

For example, as shown in FIG. 11, the transverse cross-sectional shape of a flat tube part 50 may be changed to a structure having two bellows portions 60 provided between two long side portions 51 and 52. That is, the bellows portions 60 may be provided on the short sides of the transverse cross-sectional shape of the flat tube part 50. The two bellows portions 60 are provided so as to face each other in a second direction Y1. Each bellows portion 60 has intermediate portions 61, 62, and 63, an inclined portion 64 that connects an end of the long side portion 51 and the intermediate portion 61, and an inclined portion 65 that connects the intermediate portion 61 and the intermediate portion 62. Each bellows portion 60 has an inclined portion 66 that connects the intermediate portion 62 and the intermediate portion 63, and an inclined portion 67 that connects the intermediate portion 63 and an end of the long side portion 52. The intermediate portions 61 and 63 are provided between the two long side portions 51 and 52 in a first direction X1 and outward of the two long side portions 51 and 52 in the second direction Y1. The intermediate portions 61 are provided so as to face each other in the second direction Y1. The intermediate portions 63 are provided so as to face each other in the second direction Y1. Each intermediate portion 62 is provided between the intermediate portion 61 and the intermediate portion 63 in the first direction X1 and inside of the intermediate portions 61 and 63 in the second direction Y1. The intermediate portions 62 are provided so as to face each other in the second direction Y1. The inclined portions 64, 65, 66, and 67 extend along an oblique direction intersecting both the first direction X1 and the second direction Y1 in the transverse cross section.

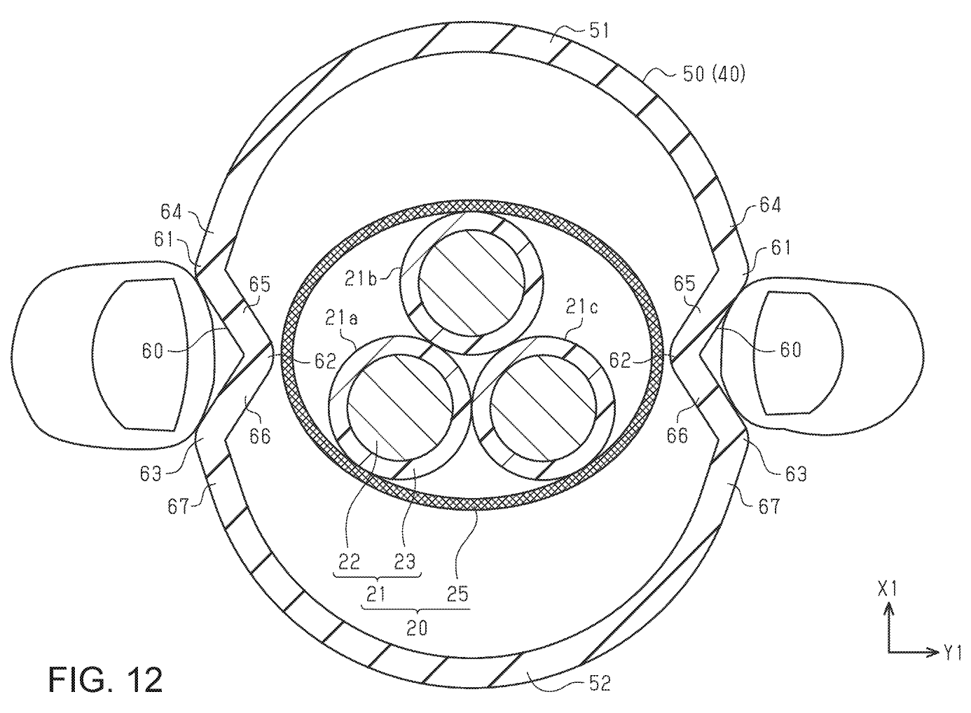

According to this configuration, each bellows portion 60 is formed between the two long side portions 51 and 52 by the inclined portion 64, the intermediate portion 61, the inclined portion 65, the intermediate portion 62, the inclined portion 66, the intermediate portion 63, and the inclined portion 67. That is, the bellows portions 60 are provided on the short sides in the transverse cross-sectional shape of the flat tube part 50. Accordingly, it is possible to, while shortening the shortest distance along the first direction X1 between the two long side portions 51 and 52, make the distance from one long side portion 51 to the other long side portion 52 longer than the shortest distance by forming the short sides into the bellows. Specifically, the distance along the inclined portion 64, the intermediate portion 61, the inclined portion 65, the intermediate portion 62, the inclined portion 66, the intermediate portion 63, and the inclined portion 67 can be formed sufficiently longer than the shortest distance. In other words, the short sides in the transverse cross-sectional shape of the flat tube part 50 can be made longer than normal. Therefore, as shown in FIG. 12, if the flat tube part 50 is pressed such that the two bellows portions 60 approach each other, the bellows portions 60 extend in the first direction X1, so that the flat tube part 50 can be suitably deformed so as to be greatly expanded in the first direction X1. Specifically, the transverse cross-sectional shape of the flat tube part 50 is deformed such that the angle formed by the inclined portions 64 and 65 and the angle formed by the inclined portions 66 and 67 are increased, and the long side portions 51 and 52 are deformed so as to be curved. In this manner, the flat tube part 50 is deformed such that the dimension along the second direction Y1 becomes small and the dimension along the first direction X1 becomes large. Accordingly, the flat tube part 50 can be suitably deformed so as to be closer to a perfect circular shape.

The transverse cross-sectional shape of the flat tube part 50 may be changed to a flat shape such as an oval shape or a rectangular shape.

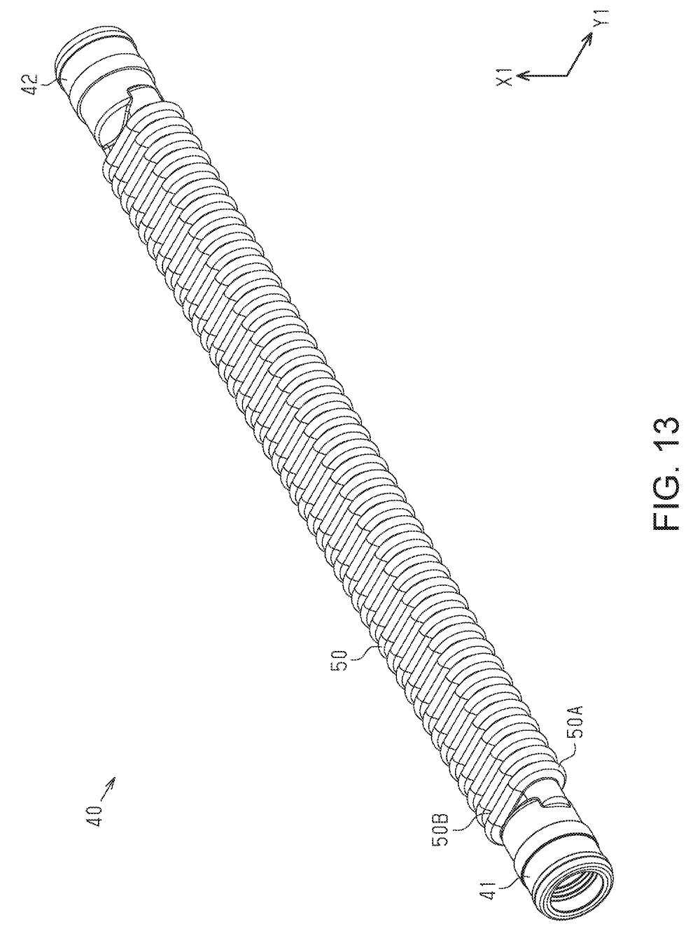

As illustrated in FIG. 13, for example, a flat tube part 50 may have a bellows structure in which annular convex portions 50A and annular concave portions 50B are alternately and continuously provided along the axial direction of the flat tube part 50. According to this configuration, providing the flat tube part 50 with a bellows structure makes it possible to easily form a bent portion of the flat tube part 50 in the axial direction.

In the modification shown in FIG. 13, the bellows structure is provided over the entire axial length of the flat tube part 50, but the present disclosure is not limited to this structure. For example, the bellows structure may be provided only in a portion of the flat tube part 50 in the axial direction. For example, the bellows structure may be provided only in a portion of the flat tube part 50 that is formed into a bent shape.

The structure of the connecting tube part 41 of the waterproof member 40 in the above embodiments can be modified as appropriate. For example, the number of lips 43 is not particularly limited. For example, the fixing part 44 may be omitted. The structure of the connecting tube part 42 can also be modified as appropriate.

The structure of the waterproof member 40 in the above embodiments may be modified as appropriate. For example, the connecting tube part 42 may be omitted. In this case, the corrugated tube 32 may also be omitted.

The coupling member 45 may be omitted.

In the above embodiments, the corrugated tubes 31 and 32 are embodied as exterior members (exterior cover). However, the present disclosure is not limited to this. For example, a resin pipe without a bellows structure may be embodied as an exterior member.

The structure of the path restriction member 70 in the above embodiments may be modified as appropriate. For example, in a path restriction member 70, the number of bent shapes and the positions at which the bent shapes are formed may be modified as appropriate in accordance with a desired path of an electric wire member 20.

In the above embodiments, the first divided body 71 and the second divided body 72 are separate components in the path restriction member 70. However, the present disclosure is not limited to this. For example, a first divided body 71 and a second divided body 72 may be integrally formed via a hinge or the like.

In the above embodiments, the path restriction member 70 is constituted of two divided bodies, that is, the first divided body 71 and the second divided body 72. However, the present disclosure is not limited to this. For example, a path restriction member 70 may be constituted of three or more divided bodies.

In the above embodiments, the path restriction member 70 is formed so as to cover the entire outer periphery of the flat tube part 50 in the circumferential direction, but the present disclosure is not limited to this. For example, a path restriction member 70 may be formed so as to cover only a portion of the outer periphery of a flat tube part 50 in the circumferential direction.

The structure of the electric wire member 20 in the above embodiments can be modified as appropriate. For example, the number of electric wires 21 is not particularly limited. For example, an electric wire member 20 may have four or more electric wires 21. The braided member 25 is embodied as an electromagnetic shielding member, but the present disclosure is not limited thereto. For example, metal foil may be embodied as an electromagnetic shielding member. For example, the braided member 25 may be omitted.

The embodiments disclosed herein should be considered to be illustrative and not restrictive in all respects. The scope of the present disclosure is defined by the claims, not by the above meaning, and is intended to include all modifications within a meaning and scope equivalent to the scope of claims.

What is claimed is:

1. A wire harness comprising:
an electric wire;
an exterior cover that is configured to cover an outer periphery of the electric wire; and
a waterproof cover that is configured to cover the outer periphery of the electric wire and be coupled to the exterior cover, wherein:
the waterproof cover has a connecting tube that is configured to cover an outer periphery of the exterior cover, and a flat tube that is formed integrally with the connecting tube,
a transverse cross-sectional shape of the exterior cover is a perfect circular shape,
a transverse cross-sectional shape of the connecting tube is a perfect circular shape,
a transverse cross-sectional shape of the flat tube is a flat shape in which a dimension along a second direction is larger than a dimension along a first direction, the first direction being orthogonal to an axial direction of the waterproof cover and the second direction being orthogonal to both the axial direction and the first direction, and
the dimension of the flat tube along the first direction is smaller than a dimension of the connecting tube along the first direction.

2. The wire harness according to claim 1, further comprising a path restrictor that is configured to be attached to an outer periphery of the flat tube and restrict a path of the electric wire.

3. The wire harness according to claim 2, further comprising:
k electric wires (k is a natural number greater than or equal to 3) that includes the electric wire, wherein:
the k electric wires are arranged in n tiers (n is a natural number less than or equal to k−1 and greater than or equal to 2) in the first direction inside the connecting tube,
the k electric wires are arranged in m tiers (m is a natural number less than or equal to n−1) in the first direction inside the flat tube, and
the path restrictor compresses the flat tube in the first direction such that the k electric wires are arranged in the m tiers inside the flat tube.

4. The wire harness according to claim 3, wherein:
m is one, and
the path restrictor compresses the flat tube in the first direction such that the k electric wires are arranged side by side along the second direction inside the flat tube.

5. The wire harness according to claim 3, wherein:
the path restrictor has a first divided body and a second divided body formed to be capable of being combined with the first divided body,
the path restrictor is formed in a tubular shape that surrounds the outer periphery of the flat tube by combining the first divided body and the second divided body,
the first divided body has a first bottom wall,
the second divided body has a second bottom wall that faces the first bottom wall in the first direction, and
a first distance along the first direction between the first bottom wall and the second bottom wall is smaller than a first dimension along the first direction of the k electric wires arranged in the n tiers.

6. The wire harness according to claim 1, wherein:
the transverse cross-sectional shape of the flat tube has two long side portions that extend along the second direction, two intermediate portions that are arranged between the two long side portions in the first direction and outward of the two long side portions in the second direction, and four inclined portions that connect both ends of the two long side portions to the two intermediate portions,
the two long side portions face each other in the first direction,
the two intermediate portions face each other in the second direction, and
the four inclined portions extend along an oblique direction intersecting both the first direction and the second direction and are shorter than the two long side portions.

7. The wire harness according to claim 6, wherein:
the four inclined portions are thicker than the two long side portions,
the two intermediate portions extend along the first direction, and
the transverse cross-sectional shape of the flat tube is an octagonal shape.

8. The wire harness according to claim 1, wherein:
the transverse cross-sectional shape of the flat tube has two long side portions that extend along the second direction and two bellows portions that are provided between the two long side portions in the first direction,
the two long side portions face each other in the first direction, and
the two bellows portions face each other in the second direction.

9. The wire harness according to claim 1, wherein the flat tube has a bellows structure in which annular convex portions and annular concave portions are alternately and continuously provided along an axial direction of the flat tube.
